(19) United States
(12) Patent Application Publication
(10) Pub. No.: US 2026/0298818 A1
(43) Pub. Date: Oct. 1, 2026

(54) METHOD AND APPARATUS FOR SENSING A REFRACTIVE DISTURBANCE

(71) Applicant: New Mexico Tech University Research Park Corporation, Socorro, NM (US)

(72) Inventor: Michael Hargather, Socorro, NM (US)

(21) Appl. No.: 19/089,588

(22) Filed: Mar. 25, 2025

Related U.S. Application Data
(60) Provisional application No. 63/569,601, filed on Mar. 25, 2024.

(51) Int. Cl. G01N 21/41

(52) U.S. Cl. CPC G01N 21/41

(57) ABSTRACT

Methods and apparatus are disclosed for sensing and measuring refractive disturbances through a specified area and/or medium. A laser emits a beam that travels through a test region and is received by a sensor. The sensor detects a deflection of the beam that is caused by the passage of the beam through a refractive disturbance in the test region. A controller, including a processor and memory, is configured to detect a change in a refractive index caused by the passage of a refractive disturbance through a specified area, such as, the passage of different fluids through an area, a change in density of the fluid, a shockwave, and/or turbulence. The controller is configured to measure and calculate disturbances within the test region based on detected changes in the refractive index.

### CROSS-REFERENCE TO RELATED APPLICATION

This application claims the benefit of U.S. Patent Application Ser. No. 63/569,601, filed on Mar. 25, 2024, which is incorporated herein by reference in its entirety.

### TECHNICAL FIELD

This disclosure generally relates to a method and apparatus for sensing and measuring a refractive disturbance. Various embodiments of the present disclosure include a laser, a sensor and a controller wherein the sensor can be used to detect a shockwave, turbulence, gas, or other refractive disturbance and to measure certain corresponding attributes of and/or related to such disturbance.

### SUMMARY

Various embodiments of the present disclosure relate to a method and apparatus for sensing and measuring refractive disturbances through a specified area and/or medium. Embodiments of the present disclosure include a laser and a sensor. The sensor is to detect deflection of a beam emitted by the laser that is caused by the passage of a refractive disturbance through a specified area, such as for example, the passage of different fluids through an area, a change in density of the fluid, a shockwave, and/or turbulence. The laser and sensor are positioned apart by some distance. This distance is related to the sensitivity of the measurement and the spacing defining the test region. Embodiments of the present disclosure further include a controller including a processor and a memory. The controller is configured to detect the known or expected refractive index of the medium within the detection area, and the controller is further configured to receive data from the sensor to calculate a change in the refractive index of the detection area. The controller may measure, calculate, and/or otherwise identify disturbances within the detection area based on changes in the refractive index. In some embodiments, the method and apparatus of the present disclosure may be applied to gases by measuring and calculating relative densities of gases within the detection area. For gases, the refractive index varies with density, so embodiments of the present invention can be used to detect density or gas differences.

In certain embodiments, different geometries could be used to provide different measurements. For example, in certain planar arrangements embodiments of the present disclosure provide single dimensional measurements. In a different embodiment, utilizing a circular geometrical area provides for additional measurement and data. In such embodiments utilizing a circular area, two or more sensor and laser combinations may be used to give additional measurements.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention.

FIG. 1 depicts a schematical representation of a method and apparatus for sensing a change in a refractive index wherein a single light source is used and wherein the light is configured to make a single pass through a detection area.

FIG. 2 depicts a schematical representation of a method and apparatus for sensing a change in a refractive index wherein a plurality of laser sources are configured to traverse a detection area and wherein a plurality of detectors are also provided.

FIG. 3 depicts an embodiment of the present invention wherein a detection beam is configured to be reflected at least once through the detection area.

FIG. 4 is a block diagram of electronic components of an example embodiment of the present invention.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Embodiments of the present disclosure relate to a method and apparatus for sensing and measuring refractive disturbances. Various embodiments include a controller, further including a processor and a memory, a laser diode source, a detection area, and sensor to detect a change in a refractive index caused by the passage of a refractive disturbance through the detection area. The information collected from the sensor may be used to determine information about the refractive disturbance, such as for example, a change in density of the gas or fluid passing through the area, a shockwave, and/or turbulence. In various embodiments, the laser and sensor are positioned apart by some distance. This distance is related to the sensitivity of the measurement and the spacing defining the test region through which any disturbances will be measured.

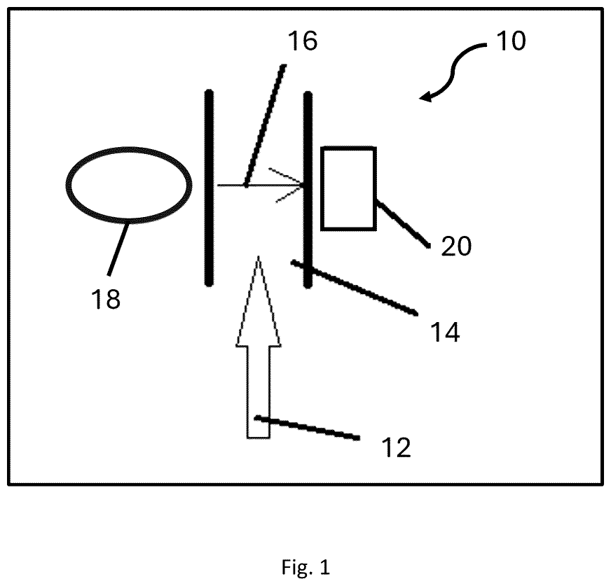

FIG. 1 illustrates one embodiment of the present disclosure. In this embodiment, a refraction disturbance detector 10 includes a laser 18 and a sensor 20. The detector 10 can preferably detect refractive disturbances 12 which pass through a detection area 14. In operation, a beam 16 emitted by the laser 18 passes through the detection area 14 and impacts the sensor 20. The sensor 20 detects information from the passage of the refractive disturbance, such as data including displacement data and/or intensity variation data that is indicative of refraction that occurs in the detection area 14, and this information can be used for the corresponding measurements of the disturbance.

The sensor 20 is configured to collect data that is indicative of a refraction of the beam 16. In some examples, the data includes intensity variation data that indicates an intensity and location of the beam 16 as received by the sensor 20 (e.g., a digital camera charged-coupled device (CCD) with an array). The sensor 20 is configured to detect an initial location and an initial intensity of the beam 16 emitted by the laser 18. When a refractive disturbance pass through and/or are otherwise present in the detection area 14, the refractive disturbance causes the location and intensity of that light to be moved. In turn, the sensor 20 detects a change in the intensity and the location of the beam 16. The change in intensity and location corresponds to refractive properties of the refractive disturbance such that the detector 10 is configured to detect a change in the refractive index by monitoring the intensity of the beam 16 travelling through the detection area 14. Further, in some examples, the data collected by the sensor 20 is displacement data that directly corresponds with a measured change in intensity of the beam 16. That is, the sensor 20 is configured to collect displacement data of the beam 16 emitted by the laser 18, with the collected displacement data being indicative of a magnitude and a direction of displacement of the received location of the beam 16.

In certain embodiments, the sensor 20 may be compact. In one embodiment, sensor 20 can comprise a 2-dimensional array sensor—for example a charged-coupled device (CCD) or another 2-dimensional sensor array as can be used for example in a digital camera. In an alternative embodiment, a Shack-Hartmann type sensor may be used. In examples with 2-dimensional sensing, the sensor 20 (e.g., a charge-coupled device) is configured to image a change in intensity as a shift or translation of the beam 16 that is indicative of a refractive disturbance. In certain alternative embodiments, sensor 20 may comprise a 3-dimensional array sensor. Additionally or alternatively, the sensor 20 includes a time-resolved sensor, such as a high speed camera, to enable temporal measurement of refractive disturbance(s).

The laser 18 is, for example, a solid-state laser, a light emitting diode (LED), a collimated light source, or any other light source able to emit a near-point beam (e.g., the beam 16) that is receivable and measurable by the sensor 20. In some examples, the laser 18 is preferably a solid-state laser that is most preferably formed from a laser diode. In other examples in which the laser 18 is an LED, the LED may be white light (polychromatic) or monochromatic. For example, the light spectrum of the laser 18 is selected so that the sensor 20 is sensitive to the light wavelength. Polychromatic sources may be utilized and analyzed in individual wavelengths or as a multiple wavelength white light source. Further, the laser 18 may be collimated to enhance light direction toward the sensor 20.

The laser 18 and the sensor 20 are preferably positioned apart by a distance. This distance is determined based on a desired sensitivity of the detector 10. In one embodiment, the width of the detection area 14, through which the beam 16 passes, is preferably at least about ¼ inch to about 20 feet in length and more preferably about one inch to about 6 inches in length.

The detection area 14 may be unenclosed or at least partially enclosed with one or more walls. In the example embodiment of FIG. 1, a pair of walls define the detection area 14. These walls may be constructed of a rigid material, such as a metal or a rigid plastic, so that the distance between the laser 18 and the sensor 20 do not change over time. In other example embodiments, the detection area 14 may not necessarily include any walls. For example, in an alternative embodiment, the laser 18 may be mounted a predefined distance away from sensor 20 that defines the detection area. For examples in which the detection area 14 is at least partially enclosed, the detection area 14 may include an opposing entrance and exit to allow a shockwave and/or other disturbance to pass through the detection area 14.

Different ambient medium may be present in the detection area 14. For example, fluid, such as a liquid and/or a gas, may be present in the detection area 14. An example ambient gas is atmospheric air. An example ambient liquid is water (e.g., when the detector 10 is used underwater).

The detection area 14 may have different geometries. For example, FIG. 1 illustrates a planar geometry using a single detection axis configuration (i.e. a single beam passing through the detection area in a single axis). In certain alternative embodiments, a two-dimensional configuration may be provided—for example by placing a row of lasers and opposingly-positioned sensors or by arranging the lasers and the detectors such that they are arranged to detect across a cross-sectional area of a detection area.

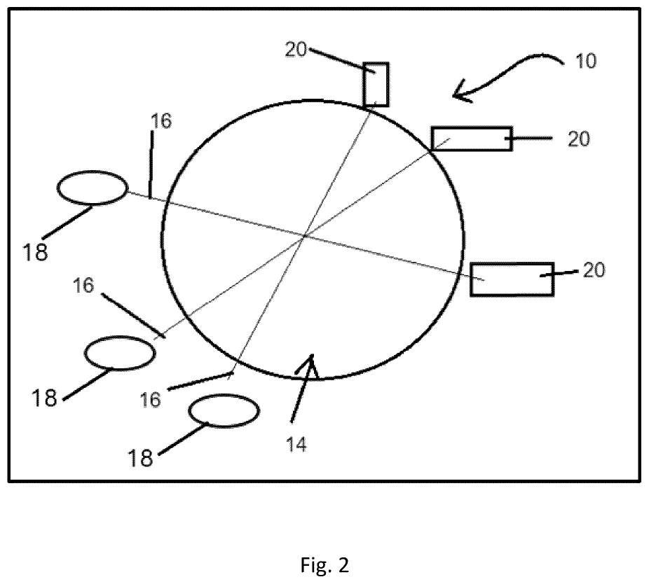

FIG. 2 illustrates an example embodiment employing a circular detection area 14, instead of the planar area depicted in FIG. 1, which allows for different and additional data to be captured by the detector 10. The example detector 10 in FIG. 2 includes a plurality of lasers 18 arranged in an arc around a circular area and a respective plurality of sensors 20 positioned across the detection area 14. As described above with respect to FIG. 1, the boundary of the circular detection area 14 may be constructed of a rigid material, such as a metal and/or rigid plastic. As illustrated in FIG. 2, each of the plurality of lasers 18 emits a respective beam 18 that passes through the detection area 14 is received by a respective one of the plurality of sensors 20. In the example embodiment depicted in FIG. 2, the plurality of lasers 18 and the plurality of sensors 20 are arranged to enable the detector 10 to detect a refractive disturbance passing through the detection area 14 in the z-axis that extends into or out of the page. The plurality of lasers 18 and the plurality of sensors 20 are arranged such that one or more beams 16 are reflected at least once to pass through detection area 14 multiple times.

In certain embodiments, geometries such as a circular detection area may be preferable to obtain different data regarding the refractive disturbance. In other alternative embodiments, the lasers 18 and the sensors 20 may be arranged to detect a 3-dimensional area (“3D”) for example by stacking a plurality of 2-dimensional configurations, in a variety of different combinations and arrangements.

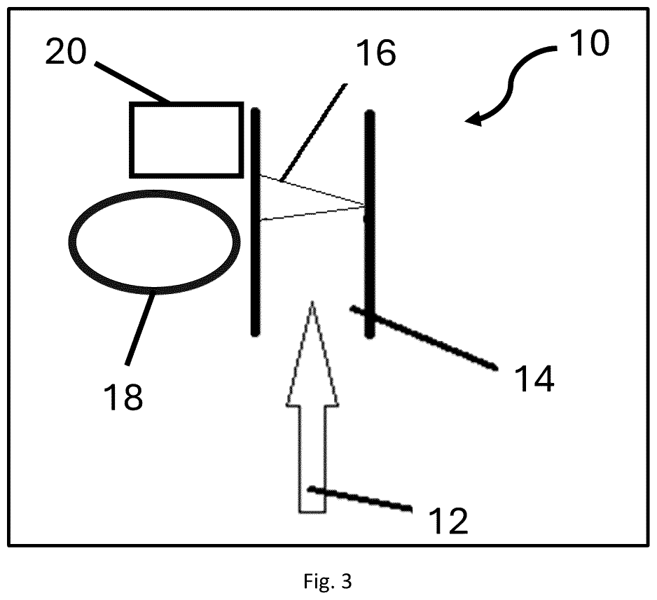

FIG. 3 illustrates another embodiment of the present disclosure in which one or more walls, which at least partially define or otherwise bound the detection area 14, have a mirrored or reflective surface disposed thereon. In this embodiment, the mirrored surface is used to cause the beam 16 to change direction within the detection area 14. Specifically, the beam 16 emitted by the laser 18 passes through the detection area 14 and changes direction when it encounters the mirrored surface. This change in direction allows the sensor 20 to gather more information regarding the refractive disturbance since the beam 16 travels along multiple axes through the detection area 14. Although the embodiment in FIG. 3 illustrates a single reflection, it should be appreciated that certain alternative embodiments may include a plurality of such reflections with a plurality of reflective surfaces. In another variation of this embodiment, a retroreflector may be used to reflect the beam 16.

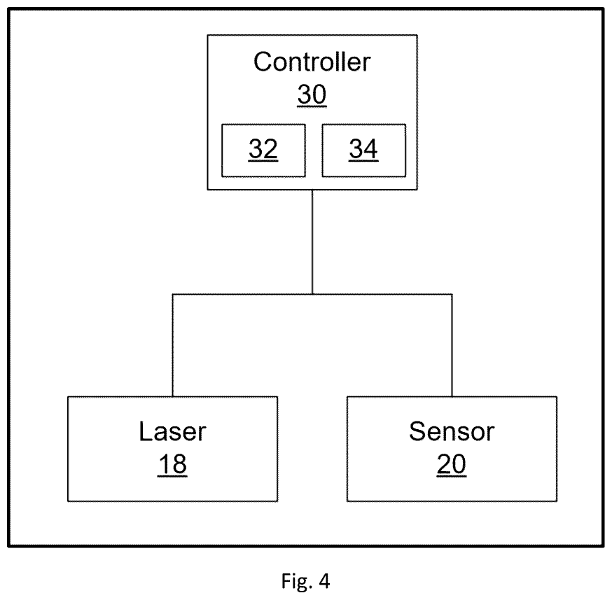

FIG. 4 depicts a block diagram of certain electronics included in the detector 10. In the illustrated examples, the electronics of the detector 10 include a controller 30, the laser(s) 18, and the sensor(s) 20. The controller 30 includes a processor 32 and memory 34. One or more of the electronics, such as the controller 30, the processor 32, the memory 34, the laser(s) 18 and/or the sensor(s) 20, may be housed on a printed circuit board (PCB). That is, the detector 10 may include a PCB on which the controller 30, the processor 32, the memory 34, the laser(s) 18, and/or the sensor(s) 20 are mounted. Further, in some embodiments, the controller 30, the processor 32, and/or the memory 34 may be integrally formed with a sensor 20 as a single unit.

The processor 32 may be any suitable processing device or set of processing devices such as, but not limited to, a microprocessor, a microcontroller-based platform, an integrated circuit, etc. The memory 34 may include one or more of volatile memory, non-volatile memory, read-only memory, etc. In some examples, the memory 34 may include a combination of multiple kinds of memory, such as volatile memory and non-volatile memory. The memory 34 is computer readable media on which one or more sets of instructions, such as the software for operating the methods of the instant disclosure, can be embedded. The instructions may embody one or more of the methods or logic as described herein. For example, the instructions reside completely, or at least partially, within any one or more of the memory 34, the computer readable medium, and/or within the processor 32 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The controller 30 is configured to calculate data and measurements indicative of refractive disturbances in the detection area 14 based on the displacement, intensity, and/or other data obtained from the sensor(s) 20. As the refractive disturbance moves through the detection area 14, the beam(s) 16 is deflected by the refraction across or through the disturbance. This deflection is captured by the sensor(s) 20. The controller 30 is configured to quantify the deflection in terms of a direction and a magnitude based on the collected data and, in turn, quantify the strength of the refractive disturbance. The controller 30 is configured to quantify the refractive disturbance based on the known arrangement and configuration of the detection area 14, the laser 18, and the sensor 20. For example, in one embodiment, a light ray traveling in the z-direction will be refracted through an angle &y due to a refractive index (n) gradient in the y-direction according to:

$${ε}_{y} = \frac{1}{n} \int \frac{\partial n}{\partial y} \partial z = \frac{Z}{{n}_{∞}} \frac{\partial n}{\partial y}$$

In this example, the refractive index of the ambient medium is no. The refraction in this example could be assumed to occur across the length between the detector and the light source, Z. The refractive index gradient field can be integrated using common numerical methods. The refractive index can be related to density if the gas medium is known using the Gladstone Dale law:

$$n = κρ + 1$$

In this example, K is the Gladstone Dale coefficient for the medium.

In certain embodiments, the output of sensor(s) 20 is preferably processed by the controller 30, such as one or more microcontrollers, digital signal processors, and/or microprocessors. In various alternative embodiments, the controller 30 can include a computer having software that is configured to process data from sensors 20, determine a shift in beam 16 thereon, and provide an output. The controller 30 may use automated computer processing to determine the refractive index variations through the math shown in the example above, or in a density estimate if the gas is known. The automated processing could identify a signal above a specified threshold, which would indicate the presence of a given event or detection, i.e., a gunshot or a gas leak. The automated detection could provide near-instantaneous feedback to the user in the hand-held implementation to identify locations of leaks.

Certain alternative embodiments, the controller 30 can include a general or specific purpose computer or distributed system programmed with computer software implementing steps described above, which computer software may be in any appropriate computer language, including but not limited to C, C++, FORTRAN, BASIC, Java, Python, Linux, MATLAB, assembly language, microcode, distributed programming languages, etc. In certain embodiments, the controller 30 of the present disclosure may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

In certain embodiments, detector 10 may be constructed as a single packaged unit, such that the detector 10 may be directly quantitative and may be used as a plug and play sensor. In certain embodiments, detector 10 can be made compact such that it can optionally be mounted on a wand or metal detector type platform to scan for leaks on pipelines or service facilities. In one such example embodiment, the detector is mounted on a mobile platform as a drone or a rover for semi- or fully-autonomous motion. Such applications may be beneficial for inspecting pipelines or other structures with limited access in remote locations. Another example application includes tele-operation of the mobile drone/rover platform. In particular this can be useful for hydrogen and/or methane leak detections described in greater detail below. In certain embodiments, the handheld device may include integrated GPS location capability to allow post-processing to determine locations of leaks.

Embodiments of the present disclosure may be used in a variety of applications. Example applications for detector 10 may be in blast testing applications to identify shock wave propagation, including in a confined region to identify shock wave propagation from multiple directions. Detector 10 can quantify shock magnitude and therefore pressure jump. In this way, detector 10 can effectively be used as an optical pressure gage for shock wave applications, or to otherwise measure brisance. In other example applications, detector 10 can be used for gunshot detection in an indoor and/or outdoor environment-including for example in urban locations. In an alternative example embodiment, multiple sensors can be used in a network to localize gunshots.

In other example applications, detector 10 can be used for aerospace applications, for example, to identify refractive turbulent flow disturbances, and/or for supersonic or transonic aircraft to detect flow disturbances across cavities, or to identify turbulent structures in a boundary layer, and/or as a flow transition sensor for boundary layer applications. In certain example embodiments, detector 10 can be used for measuring flow characteristics or potential contaminants in a flow, (for example explosive vapor detection), and/or in applications where a refractive disturbance can be measured.

In other example applications, detector 10 can be used for gas leak detection, which can have applications to hydrogen or methane pipelines or service stations. For example, if either is present in the air, it can be detected because at the same temperature and air pressure, both hydrogen and methane have a different respective refractive index than the air. In another example embodiment, the detector 10 can be used for thermal plume detection. For example, in certain example embodiments the detector 10 of the present disclosure is used to detect changes in gas density. A change in density of gases may be related to a change in temperature. Accordingly, in certain example embodiments, air is detected to assess the air at different temperatures from the ambient air. Such example embodiments may be used for applications in building HVAC (heating, ventilation, and air conditioning) testing. Such embodiments could also identify air leakage through building envelopes because the air will be at a different temperature and thus density and refractive index.

Embodiments of the present invention can be used for shock characterization for explosives and/or ballistics, as well as for turbulence characterization for hypersonic or supersonic flight vehicles. In one embodiment, a temperature sensor can be provided to detect temperature variations of fluid passing through detection area 14. Optionally, measured temperature variations can be used to offset interference caused by variations in temperature of fluid through which beam 16 passes.

An example system for monitoring a refractive index of a fluid includes a laser configured to emit a beam through a detection area in which the fluid is present. The system includes a sensor spaced apart from the laser. The sensor is configured to receive the beam emitted by the laser and collect corresponding data. The system includes a memory configured to store a predefined distance traveled by the beam between the laser and the sensor and an expected refractive index within the detection area. The system includes a processor configured to receive data from the sensor, calculate a current refractive index of the fluid in the detection area based on the data and the predefined distance between the laser and the sensor, and detect a change in a density of the fluid in response to determining that the current refractive index is different than the expected refractive index.

In some examples, when a temperature and a pressure of the fluid is constant, the processor is further configured to detect a change in a composition of the fluid based on the change in density.

In some examples, wherein, when a composition of the fluid is constant, the processor is further configured to detect a change in temperature of the fluid based on the change in density.

An example method for monitoring a refractive index of a fluid includes emitting, via a laser, a beam through a detection area in which the fluid is present. The method includes receiving, via a sensor, the beam emitted by the laser and collecting, via the sensor, data corresponding with receipt of the beam. The method includes storing, via a memory, a predefined distance traveled by the beam between the laser and the sensor and an expected refractive index within the detection area. The method includes calculating, via a processor, a current refractive index of the fluid in the detection area based on the data and the predefined distance between the laser and the sensor. The method includes detecting, via the processor, a change in a density of the fluid in response to determining that the current refractive index is different than the expected refractive index.

Some examples further include detecting, via the processor, a change in a composition of the fluid based on the change in density when a temperature and a pressure of the fluid is constant.

Some examples further include detecting, via the processor, a change in temperature of the fluid based on the change in density when a composition of the fluid is constant.

Another example system for monitoring a refractive index of a fluid includes a laser configured to emit a beam through a detection area in which the fluid is present. The system includes a sensor spaced apart from the laser. The sensor is configured to receive the beam emitted by the laser and collect corresponding data. The system includes a memory configured to store a predefined distance traveled by the beam between the laser and the sensor and an expected refractive index within the detection area. The system includes a processor configured to receive the data from the sensor, calculate a current refractive index of the fluid in the detection area based on the data and the predefined distance between the laser and the sensor, and detect a shockwave in response to determining that the current refractive index is different than the expected refractive index.

Another example system for monitoring a refractive index of a fluid includes a laser configured to emit a beam through a detection area in which the fluid is present. The system includes a sensor spaced apart from the laser. The sensor is configured to receive the beam emitted by the laser and collect corresponding data. The system includes a memory configured to store a predefined distance traveled by the beam between the laser and the sensor and an expected refractive index within the detection area. The system includes a processor configured to receive the data from the sensor, calculate a current refractive index of the fluid in the detection area based on the data and the predefined distance between the laser and the sensor, and detect a turbulent flow disturbance in response to determining that the current refractive index is different than the expected refractive index.

Another example system includes a laser configured to emit a beam through a detection area and a sensor configured to receive the beam and collect corresponding displacement data. The laser and sensor are arranged with respect to each other such that the beam travels along a single detection axis between the laser and the sensor. The system includes a controller including a processor and a memory. The controller is configured to store a predefined distance traveled by the beam between the laser and the sensor, store a refractive index of the detection area, receive the data from the sensor related to the beam emitted through the detection area, and calculate a change in the refractive index of the detection area based on the data received from the sensor.

Another example system includes a plurality of lasers. Each laser is configured to emit a respective beam through a circular detection area. The system includes a plurality of sensors. Each sensor is configured to receive a respective beam from a respective one of the plurality of lasers and collect corresponding displacement data. The plurality of lasers are arranged around the circular detection area and wherein each of the plurality of sensors is positioned across the circular detection area respective to one of the plurality of lasers. The system includes a controller including a processor and a memory. The controller is configured to store a predefined distance traveled by the beam between each pairing of one of the plurality of lasers and one of the plurality of sensors, store a refractive index of the detection area, receive the corresponding data from each of the plurality of sensors related to the respective beam emitted through the detection area, and calculate a change in the refractive index of the detection area based on the data received from the plurality of sensors.

Another example system includes a laser configured to emit a beam through a detection area defined by at least one reflective surface. The system includes a sensor configured to receive the beam and collect corresponding data. The laser and sensor are placed a distance apart on one side of a planar detection area. The laser and the sensor are arranged such that the beam reflects off the at least one reflective surface and travels a predefined distance between the laser and the sensor. The system includes a controller including a processor and a memory. The controller is configured to store the predefined distance traveled by the beam between the laser and the sensor, store a refractive index of the detection area, receive the data from the sensor related to the beam emitted through the detection area, and calculate a change in the refractive index of the detection area based on the data received from the sensor.

Note that in the specification and claims, “about”, “approximately”, and/or “substantially” means within twenty percent (20%) of the amount, value, or condition given. All computer software disclosed herein may be embodied on any non-transitory computer-readable medium (including combinations of mediums), including without limitation, hard drives (local or network storage device, solid state and non-solid-state drives), USB keys, other removable drives, ROM, and firmware. The terms, “a”, “an”, “the”, and “said” mean “one or more” unless context explicitly dictates otherwise.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1. A system for monitoring a refractive index of a fluid, the system comprising:
a laser configured to emit a beam through a detection area in which the fluid is present;
a sensor spaced apart from the laser, wherein the sensor is configured to receive the beam emitted by the laser and collect corresponding data;
a memory configured to store a predefined distance traveled by the beam between the laser and the sensor and an expected refractive index within the detection area; and
a processor configured to:
receive the data from the sensor;
calculate a current refractive index of the fluid in the detection area based on the data and the predefined distance between the laser and the sensor; and
detect a change in a density of the fluid in response to determining that the current refractive index is different than the expected refractive index.

2. The system of claim 1, wherein, when a temperature and a pressure of the fluid is constant, the processor is further configured to detect a change in a composition of the fluid based on the change in density.

3. The system of claim 1, wherein, when a composition of the fluid is constant, the processor is further configured to detect a change in temperature of the fluid based on the change in density.

4. The system of claim 1, wherein the sensor is at least one of a charged-couple device, a two-dimensional array sensor, a three-dimensional array sensor, or a Shack-Hartmann sensor.

5. The system of claim 1, wherein the laser is at least one of a solid-state laser, a light emitting diode, or a collimated light source.

6. The system of claim 1, wherein the data includes displacement data indicative of a direction and a magnitude of displacement of the beam as collected by the sensor.

7. The system of claim 1, wherein the laser and the sensor are arranged with respect to each other such that the beam travels along a single detection axis between the laser and the sensor.

8. The system of claim 1, wherein the laser and the sensor are arranged such that the beam reflects off one or more walls at least partially defining the detection area such that the beam travels along at least two detection axes through the detection area.

9. The system of claim 1, further comprising a plurality of lasers that includes the laser and a plurality of sensors including the sensor, wherein each of the plurality of lasers is configured to emit a respective beam through the detection area, wherein each of the plurality of sensors is configured to receive the beam from a respective one of the plurality of lasers.

10. The system of claim 9, the plurality of lasers and the plurality of sensors are arranged in a two-dimensional configuration.

11. The system of claim 10, wherein the detection area is circular, wherein the plurality of lasers and the plurality of sensors are arranged around a circumference of the detection area.

12. The system of claim 9, wherein the detection area is three-dimensional, and wherein the plurality of lasers and the plurality of sensors are stacked in a three-dimensional configuration.

13. The system of claim 1, wherein the data includes intensity variation data that corresponds with an intensity of the beam as measured by the sensor.

14. The system of claim 1, wherein the processor is integrally formed with the sensor as a single unit.

15. The system of claim 1, wherein the laser is configured to emit a plurality of beams at a predefined interval over a period of time, the sensor is configured to receive the plurality of beams, and the processor is configured to calculate a plurality of refractive indices of the fluid at the predefined interval over the period of time.

16. The system of claim 15, wherein the expected refractive index store in the memory equals a first of the plurality of refractive indices calculated by the processor.

17. The system of claim 15, wherein for each of the plurality of beams emitted throughout the period of time, the processor is configured to:
calculate the respective current refractive index; and
detect a change in the density of the fluid in response to determining that the respective current refractive index is different than the expected refractive index.

18. A method for monitoring a refractive index of a fluid, the method comprising:
emitting, via a laser, a beam through a detection area in which the fluid is present;
receiving, via a sensor, the beam emitted by the laser;
collecting, via the sensor, displacement data corresponding with receipt of the beam;
storing, via a memory, a predefined distance traveled by the beam between the laser and the sensor and an expected refractive index within the detection area;
calculating, via a processor, a current refractive index of the fluid in the detection area based on the displacement data and the predefined distance between the laser and the sensor; and
detecting, via the processor, a change in a density of the fluid in response to determining that the current refractive index is different than the expected refractive index.

19. The method of claim 18, further comprising detecting, via the processor, a change in a composition of the fluid based on the change in density when a temperature and a pressure of the fluid is constant.

20. The method of claim 18, further comprising detecting, via the processor, a change in temperature of the fluid based on the change in density when a composition of the fluid is constant.
